(19) United States
(12) Patent Application Publication
(10) Pub. No.: US 2025/0327280 A1
(43) Pub. Date: Oct. 23, 2025

(54) SYSTEM AND METHOD FOR COLLECTING WATER PRESENT IN THE AIR

(71) Applicants: PGMA, S.L.P., CORDOBA (ES); RED ELÉCTRICA DE ESPAÑA, S.A., Alcobendas - MADRID (ES)

(72) Inventor: José Juan MOYA MUÑOZ, Córdoba (ES)

(73) Assignees: PGMA, S.L.P., CORDOBA (ES); RED ELÉCTRICA DE ESPAÑA, S.A., Alcobendas - MADRID (ES)

(21) Appl. No.: 18/855,283

(22) PCT Filed: Apr. 5, 2023
(86) PCT No.: PCT/ES2023/070219

§ 371 Date: Oct. 8, 2024

(30) Foreign Application Priority Data
Apr. 8, 2022 (ES) P202230323

(51) Int. Cl. E03B 3/28

(52) U.S. Cl. CPC E03B 3/28

(57) ABSTRACT

A system for collecting water present in the air includes a first heat exchanger for cooling or heating and collecting water, a thermal machine to alternately heat and cool the first heat exchanger; and a blower to direct or stop an airflow to the first heat exchanger. In an operating condition of the system, the thermal machine cools the first heat exchanger and the blower directs air towards the first heat exchanger to collect the water from the air, or the blower stops the airflow towards the first heat exchanger and the thermal machine heats the first heat exchanger to regenerate the same.

### TECHNICAL FIELD OF THE INVENTION

The present invention relates to a system for collecting the water present in the water vapour found in the air, in particular, the system for collecting water present in the air includes a thermal machine such as a Stirling engine to collect said water by means of selective cooling and heating of heat exchangers containing hygroscopic materials.

### STATE OF THE ART

As is well known, water is essential for any form of life, and therefore, developing alternative ways of obtaining water is transcendental, especially in those areas where this resource is difficult to access due to geographical and/or environmental conditions. For example, in desert zones, where drinking water sources are scarce or non-existent, obtaining suitable water for, for example, human consumption is a rather complex challenge.

One way to obtain water in these regions or zones is to collect the water that is found as water vapour in the air. The main advantage of extracting water vapour from the air is that it can be obtained locally. Therefore, in any part of the world the humidity of the air can be used to collect water from it. Even in arid environments, it is possible to collect enough water from the air to fully meet people's demand for drinking water.

An example of obtaining water from water vapour in the air is disclosed in Chinese utility model CN207362921U which discloses a device for collecting water in the desert based on a Stirling cooler, which comprises a Stirling cooler, a cold head of the cooler, a condensing heat exchanger and a fan, wherein the cold head of the Stirling cooler condenses and separates moisture from dry air.

Another example of this type of device for obtaining water from air that also uses renewable energy sources is disclosed in Russian patent RU2694308C1 wherein the device comprises a housing with a thermal circuit with circulating coolant, a condenser and an evaporator in which moisture condenses, a water collector located inside the casing. The device is additionally equipped with a solar module consisting of a parabolic trough and a Stirling engine, which creates a focal region on the surface of a cylindrical photodetector. A cooling device is located in the lower portion of the Stirling engine and comprises a hydraulic pump, two hydraulic motors, a fan, a compressor that pumps the coolant through the thermal circuit which are installed in a housing covered with earth forming a mound. The Stirling engine is coupled through a crank mechanism to a hydraulic pump, which is connected by pressure lines to hydraulic motors, a fan is installed on the shaft of one of which and the other hydraulic motor is connected to a compressor. The lower portion of the thermal circuit with the condenser and the compressor is buried in the ground, and the upper portion of the thermal circuit with the evaporator is inside the housing. Under the evaporator there is a water collector, in the lower portion of which a water pipe is installed that delivers the extracted water to the consumer.

In the solutions presented in the aforementioned patent documents, as has been seen, a refrigerator or Stirling engine is used to extract water from the water vapour contained in the air. However, alternative solutions that make more effective use of the Stirling engine are required to collect water from the air more efficiently.

### DESCRIPTION

In order to solve the need detected in the state of the art, the present invention provides the system for collecting water present in the air of claim 1.

Within the context of the invention, in the expression “collecting water present in the air”, “air” is understood as the air that is available at local atmospheric pressure. However, the person skilled in the art will understand that the air can also be at pressures other than atmospheric pressure, the system being capable of blowing air under these conditions.

The claimed invention therefore relates to a system for collecting water present in the air comprising a first heat exchanger configured to be cooled or heated and to collect and/or store water, a thermal machine configured to heat or cool the first heat exchanger; and a blower configured to direct and stop an airflow from an inlet towards the first heat exchanger.

Thus, in an operating condition of the system, the thermal machine cools the first heat exchanger and the blower directs the air towards said first exchanger, when said exchanger is being cooled and is kept cold by the thermal machine, such that when at least a portion of the water present in the air blown in from the outside and directed towards said first heat exchanger by the blower is collected in said first exchanger, wherein the airflow can be maintained until a pre-established level, for example by weight of water in the first exchanger, or a saturation level is reached.

Next, to extract the water collected in the first exchanger and regenerate the same, the blower interrupts the air flow towards the first exchanger, and the thermal machine heats said first heat exchanger, wherein the water that has been collected in the first exchanger is extracted.

In an alternative embodiment, the system comprises a second heat exchanger, the thermal machine also being configured to cool and heat the second heat exchanger and the blower being, at the same time, configured to direct and inject air to both the first heat exchanger and the second heat exchanger. In this way, in an operative condition of the system, the thermal machine cools the first heat exchanger and the blower directs the air towards said first exchanger such that at least part of the water present in the air flow is collected in said first exchanger and, at the same time, the thermal machine heats the second heat exchanger, such that the water that has been collected in said second exchanger, if any, is extracted and, wherein, the thermal machine then cools the second heat exchanger and the blower directs the air towards said second exchanger, such that at least a part of the water present in the airflow directed towards said second exchanger is collected, while said second exchanger is being cooled and is kept cold by the thermal machine and, at the same time, the thermal machine heats the first heat exchanger to regenerate it, such that the water collected in the first exchanger is extracted.

Alternatively, the thermal machine is configured to simultaneously cool the first heat exchanger and the second exchanger, or to simultaneously heat said heat exchangers, such that the air blower injects the air into the first heat exchanger and/or into the second heat exchanger. In this way, the heat exchangers can capture water from the air at the same time, or be regenerated simultaneously, or also operate alternately, as previously described.

In the context of the invention, the term “blower” refers to devices capable of blowing air into the system, for example, but not limited to, fans, compressors, injectors.

In the context of the invention, the term “heat exchanger” refers to a device designed to enable heat transfer between at least two fluids or between a fluid and a solid that is in contact with the fluids.

In the context of the invention, the term “thermal machine” refers to the set of mechanical elements that allows energy to be exchanged, generally through an axis, by means of the change in energy of a fluid that varies its density significantly when passing through the machine.

Furthermore, according to a preferred embodiment of the invention, the thermal machine is a Stirling engine actuated by an engine or a transmission operatively connected to said Stirling engine, such that the reciprocating element(s) of said Stirling engine is moved by said engine or transmission, in this way the Stirling engine is configured to work in Reverse mode, such that mechanical energy is not generated in the shaft from the temperature difference, but it is mechanical energy applied to the shaft, or to the flywheel of said Stirling engine, that causes the temperature difference, which is used to selectively heat or cool the first or second heat exchanger.

Alternatively, the thermal machine is comprised of two Stirling engines that are independent of one another, wherein each of said Stirling engines is respectively connected to the first heat exchanger and to the second heat exchanger, wherein the two Stirling engines are each configured to heat or cool the heat exchanger to which it is connected, such that, in an operating condition of the system, one Stirling engine cools or heats the first heat exchanger and/or the other Stirling engine cools or heats the second heat exchanger, wherein the blower directs air to the first heat exchanger and/or to the second heat exchanger, depending on the operating requirements of the system.

In the context of the invention, the term “Stirling engine” refers to a heat engine that operates by cyclical compression and expansion of air or another gas (working fluid) at different temperature levels that produce a conversion of heat energy to mechanical energy. More specifically, it is a regenerative closed-cycle heat engine with a permanent gaseous fluid. In this definition, closed cycle describes a thermodynamic system in which fluid is permanently contained in the system, and regenerative describes the use of a specific type of heat exchange and thermal storage, known as the regenerator.

In the context of the Invention, the term “motor” refers to a means to move something, or a device intended to produce movement at the expense of another source of energy.

In alternative embodiments, each of the first and second heat exchangers comprises a hygroscopic material, such that when the exchanger is cooled by the action of the thermal machine, the water contained in the air blown towards the exchanger is adsorbed by the hygroscopic material, while when the exchanger is heated, the water adsorbed by the hygroscopic material is released (desorption) and can be extracted from any of the exchangers and used, fulfilling the purpose of the invention.

In the context of the invention, the term “hygroscopic material” refers to hygroscopic materials capable of absorbing or adsorbing water molecules from the surrounding air, and then having the ability to desiccate, by means of, for example, an increase in temperature, totally or partially releasing the adsorbed water (desorption).

In other alternative embodiments, the system comprises a valve linked to the blower configured to direct air from the blower towards the first exchanger or the second exchanger.

In alternative embodiments, the system comprises control means configured to control the overall operation. Therefore, the control means are fed data/information coming from sensors arranged in the heat exchangers (for example, humidity, temperature, weight sensors, among others), sensor for the cycle direction of the thermal machine, pressure sensors of the blower and/or or the flow direction of the blower, such that, based on the data obtained from the sensors, the control means generate instructions that change, for example, reverse the operating cycle of the thermal machine (Stirling engine), act on the valve to direct the air from one exchanger to the other, regulate the flow of air blown by the blower, and in general, all the functioning/operation of the system.

The invention also discloses a method for collecting water present in the air that uses the system for collecting water from the air as described until now.

The main advantage of the system of the invention is to collect and harness the water present in the air at atmospheric pressure, that is, collect the water contained in the air in the form of vapour, making optimal use of the energy and the characteristics of the Stirling engine, being able to collect a greater amount of water than in similar systems that also collect water from the air, since while the adsorption of water vapour is being carried out in one of the heat exchangers (the one that is being cooled), in the other exchanger the adsorbed water is extracted by heating the same, such that, when the way the thermal machine works is changed because, for example, the exchanger that is cold cannot adsorb more water, the latter is heated to extract the adsorbed water, while the other exchanger is cooled to capture the water, and thus the operation of the thermal machine can be changed again so that the collection of water is carried out continuously.

### BRIEF DESCRIPTION OF THE FIGURES

The foregoing and other advantages and features will be better understood based on the following detailed description of several embodiments in reference to the attached drawings, which must be interpreted in an illustrative and non-limiting manner and in which:

FIG. 1 is a general schematic view of the system for collecting water from the air of the invention.

FIG. 2 is a general schematic view of the system for collecting water from the air of the invention wherein the thermal machine is cooling the first heat exchanger, while heating the second heat exchanger.

FIG. 3 is a general schematic view of the system for collecting water from the air of the invention wherein the thermal machine is heating the first heat exchanger, while cooling the second heat exchanger.

### DETAILED DESCRIPTION OF AN EXEMPLARY EMBODIMENT

The following detailed description provides numerous specific details as examples to provide a thorough understanding of the relevant teachings. However, it will be apparent to those skilled in the art that the present teachings can be implemented without such details.

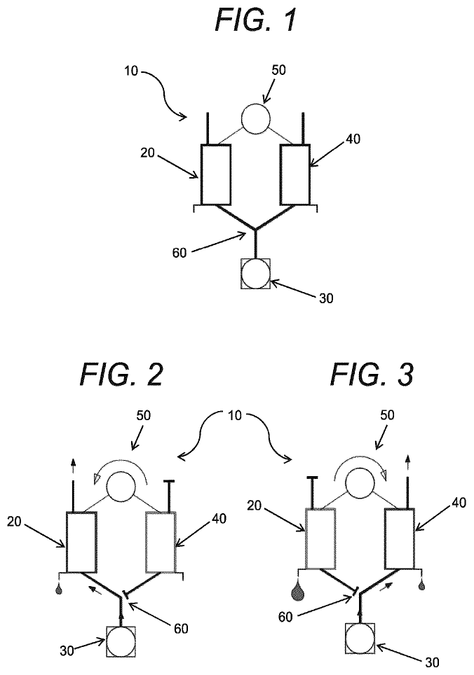

As can be seen in FIG. 1, in the preferred embodiment of the invention, the invention discloses a system for collecting water present in the air, system 10 hereinafter, comprising a thermal machine 50 which, preferably, is a Stirling engine 50 and will be referred to as such in this detailed description, which can be actuated by mechanical energy applied directly to said Stirling engine 50, such that it works as a reverse Stirling cycle. Therefore, with this way of actuating the Stirling engine 50, instead of obtaining mechanical energy by means of the application of heat, heat and cold are obtained after the application of said mechanical energy.

This way of operating or applying energy to the Stirling engine 50 generates different temperature sources at the output of the Stirling engine 50, one cold and one hot. If the energy applied to the Stirling engine 50 is exerted in the opposite direction, reversing the cycle, the temperature sources at the outlet of the engine 50 are inverted, the cold source becomes hot and vice versa.

There is a first heat exchanger 20 and a second heat exchanger 40 linked with each source, wherein each of said exchangers 20, 40 houses hygroscopic material therein.

Likewise, the system 10 comprises a blower 30 configured to generate an air current that is directed in a suitable manner towards the first 20 or second 40 heat exchanger as required.

When the Stirling engine 50 cools any of the heat exchangers 20, 40, the cold temperature will favour the adsorption of the water vapour present in the air.

Therefore, the blower 30 will push air through the heat exchanger that is cold or cooling until saturation of the hygroscopic material in the exchanger has been reached, reaching a preset reference value in water content (for example, based on the increase in weight acquired by the heat exchanger during the passage of air and water adsorption). This situation is illustrated in FIG. 2, wherein the first heat exchanger 20 is cooled by the Stirling engine 50, in which water vapour from the air is adsorbed by the hygroscopic material of the first heat exchanger 20.

Additionally, and given the condensation capacity of water, in this cold exchanger or in cooling, water can also be obtained directly by the condensation of part of the water vapour when the air current is cooled as it passes through the cold heat exchanger.

In order to obtain the water collected in the first heat exchanger 20, the desorption of the hygroscopic material from said first heat exchanger 20 must be carried out. Therefore, the direction of the mechanical energy applied to the Stirling engine 50 is changed to reverse the cycle, in such a way that, at the output of said Stirling engine 50, the cold source becomes the hot source and vice versa. As seen in FIG. 3, with proper synchronisation, a valve 60 operatively connected to the blower 30, in the particular embodiment a three-way valve, is arranged to direct the air flow from the blower 30 towards one source or another, that is towards the first heat exchanger 20 or the second heat exchanger 40, changing and redirecting the air current to pass through the heat exchanger, the second 40 in this example, which was previously hot and now becomes cold having reversed the cycle of the Stirling engine 50.

Once the hygroscopic material of the first heat exchanger 20 is regenerated through the heat applied to said first heat exchanger 20, extracting the water it contained, that is, recovering the water that is intended to be collected and that is directed to other subsequent stages for its treatment, dispensing or storage, the direction of the mechanical energy applied to the Stirling engine 50 is reversed again, supplying cold to the first heat exchanger 20 and heat to the second heat exchanger 40 again. Likewise, the valve 60 is actuated to redirect the air flow from the blower 30 towards the first heat exchanger 20 that is being cooled, while the second heat exchanger 40 is regenerated by applying heat thereto, recovering the water upon desiccating the hygroscopic material of said second exchanger 40. This situation is illustrated in FIG. 2. This is how the whole process begins again, which will repeat itself cyclically.

At all times, and whenever the system is in operation, that is, in an operating condition of the system, and depending on the direction of the application of mechanical energy to the Stirling engine 50, at the outlet of the Stirling engine 50 there will be a cold source to cool the first heat exchanger 20 or the second heat exchanger 40 to favour the adsorption of the water contained in the air, and there will be a hot source to heat the first heat exchanger 20 or the second heat exchanger 40, regenerating the hygroscopic material contained in the heat exchanger 20, 40 extracting the water for its use.

In addition, in the heat exchanger linked to the cold source, that is, the one that is being cooled by the Stirling engine 50, it is possible to collect or obtain a certain amount of water directly, without having to wait for the regeneration of said heat exchanger that is collecting the same through the hygroscopic material. This is possible due to the condensation of water vapour when cooling the air current that flows through the heat exchanger that is being cooled. Therefore, as seen in FIG. 2, in the first heat exchanger 20 that is being cooled, a part of the water that is in the airflow that is being cooled condenses and is collected or recovered from the first heat exchanger 20. This is illustrated as a small drop of water coming out of the heat exchanger 20. In contrast, when the heat exchanger is regenerated, for example, the first heat exchanger 20 in FIG. 3, much more water is withdrawn, as illustrated in the form of a large water drop coming out of the first heat exchanger 20, while less water (small water drop) is extracted from the second heat exchanger 40 which is being cooled. Thus, and according to the requirements, this directly obtained water can be supplied by the system.

Alternatively, all the components of the system can be arranged in a casing (not shown), such that at least the thermal machine 50, the heat exchangers 20, 40 and the blower have been compactly incorporated in said casing.

1-11. (canceled)

12. A system for collecting water present in the air, the system comprising:
a first heat exchanger configured to be cooled or heated and to collect water;
a thermal machine configured to alternately heat and cool the first heat exchanger; and
a blower configured to direct or stop an airflow to the first heat exchanger;
wherein, in an operating condition of the system, the thermal machine cools the first heat exchanger and the blower directs the air towards said first heat exchanger to collect water from the air; or the blower stops the airflow towards the first heat exchanger and the thermal machine heats the first heat exchanger to regenerate the same.

13. The system according to claim 12, comprising a second heat exchanger configured to be cooled or heated and to collect water,
the thermal machine being configured to heat and cool the second heat exchanger and the blower being configured to direct or stop the airflow to the second heat exchanger,
wherein, in an operating condition of the system the thermal machine cools the first heat exchanger and the blower directs the air towards said first heat exchanger to collect the water from the air and, at the same time, the thermal machine heats the second heat exchanger to regenerate the same; or the thermal machine cools the second heat exchanger and the blower directs the air towards said second heat exchanger to collect the water from the air and, at the same time, the thermal machine heats the first heat exchanger to regenerate the same.

14. The system of claim 12, wherein the thermal machine is a Stirling engine configured to operate in reverse mode, such that said Stirling engine is actuated by an engine operatively connected thereto for that purpose.

15. The system according to claim 12,
wherein the thermal machine comprises two independent Stirling engines, each of said Stirling engines being connected to the first heat exchanger, one of the Stirling engines being configured to cool the first heat exchanger, while the other Stirling engine is configured to heat the first heat exchanger.

16. The system according to claim 13,
wherein the thermal machine comprises two independent Stirling engines, each of said Stirling engines being connected to the first heat exchanger and to the second heat exchanger,
wherein, in an operating condition of the system, one Stirling engine cools or heats the first heat exchanger or the other Stirling engine cools or heats the second heat exchanger, wherein the blower directs the air to the first heat exchanger or to the second heat exchanger.

17. The system according of claim 13, wherein each of the first and second heat exchangers comprises a hygroscopic material, such that, when the first or second heat exchanger is cooled by the action of the thermal machine, the water contained in the air is adsorbed by the hygroscopic material, while, when the first or the second heat exchanger is heated, the water adsorbed by the hygroscopic material is desorbed.

18. The system of claim 13, further comprising a valve linked to the blower configured to direct the air from the blower towards the first exchanger or the second exchanger.

19. A method for collecting water present in the air using a system or collecting water present in the air, the system comprising:
a first heat exchanger configured to be cooled or heated and to collect water;
a thermal machine configured to alternately heat and cool the first heat exchanger; and
a blower configured to direct or stop an airflow to the first heat exchanger;
wherein, in an operating condition of the system, the thermal machine cools the first heat exchanger and the blower directs the air towards said first heat exchanger to collect water from the air; or the blower stops the airflow towards the first heat exchanger and the thermal machine heats the first heat exchanger to regenerate the same,
the method comprising the steps of:
cooling the first heat exchanger by means of the thermal machine;
directing an airflow by means of the blower towards the first heat exchanger to collect water from the air; and
maintaining the airflow towards the first heat exchanger until a reference value of collected water is reached.

20. The method according to claim 19, wherein, when the reference value of collected water is reached in the step of maintaining the airflow towards the first heat exchanger until a reference value of collected water is reached, it comprises the steps of:
stopping the airflow by means of the blower towards the first heat exchanger;
heating the first heat exchanger by means of the thermal machine; and
extracting the water collected from the first heat exchanger.

21. The method according to claim 20, further comprising the steps of:
cooling the second heat exchanger by means of the thermal machine;
directing the airflow by means of the blower towards the second heat exchanger to collect water from the air; and
maintaining the airflow towards the second heat exchanger until a reference value of collected water is reached.

22. The method according to claim 21, wherein, when the reference value of collected water is reached in the step of maintaining the airflow towards the second heat exchanger until a reference value of collected water is reached, it comprises the steps of:
stopping the airflow by means of the blower towards the second heat exchanger;
heating the second heat exchanger by means of the thermal machine; and
extracting the water collected from the second heat exchanger.
